(19) United States
(12) Patent Application Publication
(10) Pub. No.: US 2026/0145742 A1
(43) Pub. Date: May 28, 2026

(54) VEHICLE LOWER PORTION STRUCTURE

(71) Applicant: TOYOTA JIDOSHA KABUSHIKI KAISHA, Aichi-ken (JP)

(72) Inventor: Katsunori HIGASHIHARA, Toyota-shi (JP)

(21) Appl. No.: 19/363,651

(22) Filed: Oct. 21, 2025

(30) Foreign Application Priority Data
Nov. 28, 2024 (JP) 2024-207748

(51) Int. Cl. B62D 21/15; B60J 5/04; B62D 25/02

(52) U.S. Cl. CPC B62D 21/157; B60J 5/04; B62D 25/025

(57) ABSTRACT

A vehicle lower portion structure includes: a rocker that is provided at a side section of a vehicle and that extends in a vehicle front-rear direction; a rocker molding that is disposed further toward a vehicle width direction outer side than the rocker and that covers the rocker from the vehicle width direction outer side; a first impact absorbing member that is provided at an interior of the rocker; and a second impact absorbing member that is disposed between the rocker and the rocker molding, at a position that overlaps with the first impact absorbing member as viewed from a vehicle width direction.

### CROSS-REFERENCE TO RELATED APPLICATION

This application is based on and claims priority under 35 USC 119 from Japanese Patent Application No. 2024-207748 filed on Nov. 28, 2024, the disclosure of which is incorporated by reference herein.

### BACKGROUND

### Technical Field

The present disclosure relates to a vehicle lower portion structure.

### Related Art

Japanese Patent Application Laid-Open (JP-A) No. 2010-208473 discloses a structure in which an air dam is provided at a vehicle width direction outer side of a side sill (rocker). Further, Japanese Patent Application Laid-Open (JP-A) No. 2010-208473 discloses that an impact load during a side-on collision is transmitted to the side sill earlier, by disposing a foam material at an interior of the air dam, and providing the foam material and a side sill beam inside the side sill at corresponding positions.

However, there is room for improvement from the perspective of effectively absorbing an impact load during a side-on collision of a vehicle.

### SUMMARY

An object of the present disclosure is to obtain a vehicle lower portion structure that is capable of effectively absorbing an impact load during a side-on collision of a vehicle.

A vehicle lower portion structure of a first aspect includes: a rocker that is provided at a side section of a vehicle and that extends in a vehicle front-rear direction; a rocker molding that is disposed further toward a vehicle width direction outer side than the rocker and that covers the rocker from the vehicle width direction outer side; a first impact absorbing member that is provided at an interior of the rocker; and a second impact absorbing member that is disposed between the rocker and the rocker molding, at a position that overlaps with the first impact absorbing member as viewed from a vehicle width direction.

In the vehicle lower portion structure of the first aspect, a rocker is provided at a side section of a vehicle, and the rocker extends in a vehicle front-rear direction. Further, a rocker molding is provided further toward a vehicle width direction outer side than the rocker, and the rocker molding covers the rocker from the vehicle width direction outer side. Furthermore, a first impact absorbing member is provided at an interior of the rocker. Therefore, during a side-on collision of the vehicle, at least a portion of an impact load is absorbed by the first impact absorbing member.

Further, a second impact absorbing member is disposed between the rocker and the rocker molding, at a position that overlaps with the first impact absorbing member as viewed from the vehicle width direction. This enables an impact load that is input to the rocker molding during a side-on collision of the vehicle to be effectively absorbed by the first impact absorbing member and the second impact absorbing member.

A vehicle lower portion structure of a second aspect is the vehicle lower portion structure of the first aspect, wherein: the rocker includes a rocker outer panel, a rocker inner panel, and a rocker reinforcement that is provided between the rocker outer panel and the rocker inner panel and that divides a space into a left space and a right space; the first impact absorbing member includes an outer side absorbing member that is disposed between the rocker outer panel and the rocker reinforcement, and an inner side absorbing member that is disposed between the rocker inner panel and the rocker reinforcement; and the outer side absorbing member, the inner side absorbing member, and the second impact absorbing member are disposed at positions that overlap with each other as viewed from the vehicle width direction.

In the vehicle lower portion structure of the second aspect, the rocker includes a rocker outer panel, a rocker inner panel, and a rocker reinforcement, and the internal space of the rocker is divided into a left space and a right space by the rocker reinforcement. Further, an outer side absorbing member, which is disposed between the rocker outer panel and the rocker reinforcement, an inner side absorbing member, which is disposed between the rocker inner panel and the rocker reinforcement, and the second impact absorbing member are disposed at positions that overlap with each other as viewed from the vehicle width direction. This enables an impact load that is input during a side-on collision to be effectively absorbed by the three absorbing members.

A vehicle lower portion structure of a third aspect is the vehicle lower portion structure of the first aspect, wherein: a side door is provided further toward the vehicle width direction outer side than the rocker molding; and a lower portion of the side door is disposed at a position that overlaps with the first impact absorbing member and the second impact absorbing member as viewed from the vehicle width direction.

In the vehicle lower portion structure of the third aspect, an impact load is input to the rocker molding from the side door during a side-on collision, such that the impact load can be distributed in the vehicle front-rear direction more than in a case in which an impact load is directly input to the rocker molding.

A vehicle lower portion structure of a fourth aspect is the vehicle lower portion structure of the first aspect, wherein: the rocker molding includes a vertical wall portion that covers a vehicle width direction outer side of the rocker, and a lateral wall portion that covers a vehicle lower side of the rocker; and the lateral wall portion is fixed to an undercover that configures a lower face of the vehicle.

In the vehicle lower portion structure of the fourth aspect, a lateral wall portion that configures the rocker molding is fixed to an undercover, such that a portion of a load during a side-on collision can be transmitted to the side opposite to the collision side via the rocker molding and the undercover.

A vehicle lower portion structure of a fifth aspect is the vehicle lower portion structure of the first aspect, wherein: the rocker molding includes an adjacent portion that is adjacent to the rocker, and a separation portion that is separated from the rocker, in plan view; and the second impact absorbing member is disposed, at the separation portion, between the rocker and the rocker molding.

In the vehicle lower portion structure of the fifth aspect, even in a case in which the side door is provided with a design face that is curved, the second impact absorbing member is disposed between the rocker molding and the rocker, thereby enabling collision safety performance during a side-on collision to be ensured.

As explained above, the vehicle lower portion structure according to the present disclosure enables an impact load to be effectively absorbed during a side-on collision of a vehicle.

### BRIEF DESCRIPTION OF THE DRAWINGS

An exemplary embodiment of the present disclosure will be described in detail based on the following figures, wherein:

FIG. 1 is a schematic side view illustrating a vehicle to which a vehicle lower portion structure according to an exemplary embodiment has been applied;

FIG. 2 is a cross-sectional view taken along line 2-2 in FIG. 1; and

FIG. 3 is a cross-sectional view taken along line 3-3 in FIG. 2.

### DETAILED DESCRIPTION

Explanation follows regarding a vehicle lower portion structure according to an exemplary embodiment, with reference to the drawings.

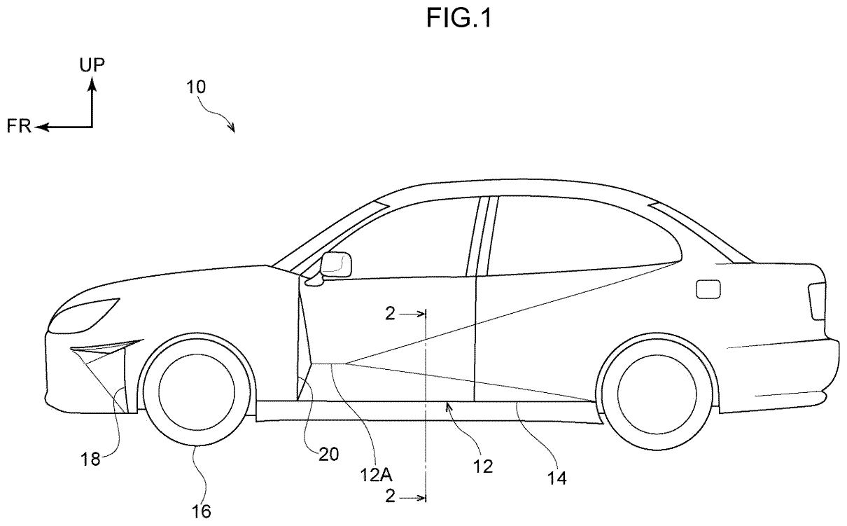

FIG. 1 is a schematic side view illustrating a vehicle lower portion structure according to an exemplary embodiment. Note that in the drawings, the arrow FR, the arrow UP, and the arrow OUT respectively indicate a vehicle frontward direction, a vehicle upward direction, and vehicle width direction outer side of a vehicle. In the following explanation, in cases in which front-rear, up-down, and left-right directions are described without any particular notation to the contrary, these indicate front and rear in a vehicle front-rear direction, up and down in a vehicle up-down direction, and left and right in a vehicle left-right direction (width direction), respectively.

As illustrated in FIG. 1, a front side door 12 and a rear side door 14 are provided at a side section of a vehicle 10 to which a vehicle lower portion structure has been applied. The front side door 12 is positioned at a front portion of the vehicle 10, and is attached so as to be capable of pivotally mounted at its front end portion. Further, the rear side door 14 is disposed further toward a vehicle rear side than the front side door 12, and is attached so as to be capable of opening and closing about a front end portion.

Note that in the present exemplary embodiment, as an example, the front side door 12 and the rear side door 14 are formed in a concavo-convex shape. Specifically, a concave portion 12A is provided at a front portion of the front side door 12, and an inclined face having a substantially triangular shape in side view is formed from the concave portion 12A toward the rear. Forming the front side door 12 and the rear side door 14 in a concavo-convex shape in this manner enables a vehicle having a unique design face to be realized.

Further, in the present exemplary embodiment, an air guide hole 18 is formed further toward the front than a front wheel 16, and a configuration is such that air that has passed through the air guide hole 18 and gone past the front wheel 16 is discharged from a discharge hole 20 at the front portion of the front side door 12. Namely, a configuration is such that the discharge hole 20 can be formed without increasing the vehicle width, by forming the concave portion 12A in the front side door 12.

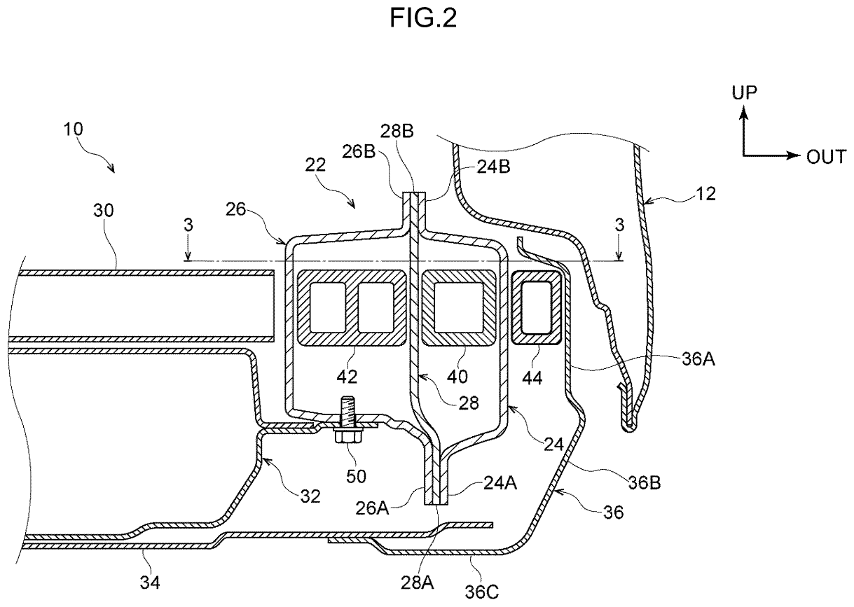

FIG. 2 is a cross-sectional view taken along line 2-2 in FIG. 1. As illustrated in FIG. 2, a rocker 22 that extends in the vehicle front-rear direction is provided at the side section of the vehicle 10. The rocker 22 is a skeleton member that has a closed cross-section structure and that is disposed at a vehicle width direction inner side of the front side door 12 and the rear side door 14, and that includes a rocker outer panel 24, a rocker inner panel 26, and a rocker reinforcement 28.

The rocker outer panel 24 is formed with a cross-section that is substantially hat-shaped and that is open at a vehicle width direction inner side as viewed from the vehicle front-rear direction, and an outer side lower flange 24A is formed at a lower end portion of the rocker outer panel 24. Further, an outer side upper flange 24B is formed at an upper end portion of the rocker outer panel 24.

The rocker inner panel 26 is disposed further toward the vehicle width direction inner side than the rocker outer panel 24, and is formed with a cross-section that is substantially hat-shaped and that is open at a vehicle width direction outer side as viewed from the vehicle front-rear direction. Further, an inner side lower flange 26A is formed at a lower end portion of the rocker inner panel 26. Further, an inner side upper flange 26B is formed at an upper end portion of the rocker inner panel 26.

The rocker reinforcement 28 is provided between the rocker outer panel 24 and the rocker inner panel 26, and divides a space formed by the rocker outer panel 24 and the rocker inner panel 26 into a left space and a right space. A center side lower flange 28A is formed at a lower end portion of the rocker reinforcement 28, and the outer side lower flange 24A, the inner side lower flange 26A, and the center side lower flange 28A are joined by welding or the like.

A center side upper flange 28B is formed at an upper end portion of the rocker reinforcement 28, and the outer side upper flange 24B, the inner side upper flange 26B, and the center side upper flange 28B are joined by welding or the like.

A cross member 30 is provided at a vehicle width direction inner side of the rocker 22. The cross member 30 extends in the vehicle width direction, and extends between left and right rockers 22.

A battery case 32 is provided below the cross member 30. A battery, which is not illustrated in the drawings, is housed in the battery case 32, and electric power that is stored in the battery is supplied to a drive source such as a motor.

Note that the battery case 32 of the present exemplary embodiment is fastened to the rocker inner panel 26 by a bolts 50, for example.

An undercover 34 is provided below the battery case 32. The undercover 34 extends in the vehicle width direction and the vehicle front-rear direction, and covers the entirety of battery case 32 from below. Further, both vehicle width direction end portions of the undercover 34 extend further toward the vehicle width direction outer side than the battery case 32, and are positioned below the rocker 22.

A rocker molding 36 that covers the rocker 22 from the vehicle width direction outer side is disposed further toward the vehicle width direction outer side than the rocker 22. The rocker molding 36 includes, as viewed from the front-rear direction, a vertical wall portion 36A that extends in the vehicle up-down direction and covers a vehicle width direction outer side of the rocker 22, a lateral wall portion 36C that extends in the vehicle width direction and covers a vehicle lower side of the rocker 22, and an inclined wall portion 36B that connects the vertical wall portion 36A and the lateral wall portion 36C.

The vertical wall portion 36A is provided at a position that overlaps with the rocker 22 and the cross member 30 as viewed from the vehicle width direction, and a gap is provided between the rocker outer panel 24 and the vertical wall portion 36A. Further, a lower end portion of the vertical wall portion 36A is connected to the inclined wall portion 36B.

The inclined wall portion 36B inclines toward the vehicle width direction inner side from a vehicle upper side toward a vehicle lower side, and a lower end portion of the inclined wall portion 36B is connected to the lateral wall portion 36C. The lateral wall portion 36C extends toward the vehicle width direction inner side from the lower end portion of the inclined wall portion 36B, and an end portion of the lateral wall portion 36C is fixed to a lower face of the undercover 34 that configures a lower face of the vehicle 10. There is no particular limitation to a method of fixing the lateral wall portion 36C to the undercover 34, and the lateral wall portion 36C may be mechanically fastened to the undercover 34 by a bolt, a nut, a rivet, or the like, or the lateral wall portion 36C may be joined by welding or the like to the undercover 34.

In the present exemplary embodiment, an outer side absorbing member 40 and an inner side absorbing member 42, which serve as a first impact absorbing member, are provided at an interior of the rocker 22. The outer side absorbing member 40 is disposed inside a space between the rocker outer panel 24 and the rocker reinforcement 28, and is fixed to the rocker outer panel 24 or the rocker reinforcement 28.

Further, the outer side absorbing member 40 is formed of a hollow member, and is configured so as to be collapsed and be able to absorb an impact load when an impact load is input from the vehicle width direction. Namely, the outer side absorbing member 40 has a structure with lower rigidity than the rocker 22.

The inner side absorbing member 42 is disposed inside a space between the rocker inner panel 26 and the rocker reinforcement 28, and is fixed to the rocker inner panel 26 or the rocker reinforcement 28. Further, similarly to the outer side absorbing member 40, the inner side absorbing member 42 is formed of a hollow member, and is configured so as to be collapsed and be able to absorb an impact load when an impact load is input from the vehicle width direction.

Note that in the present exemplary embodiment, as an example, a partition wall that divides an internal space into a left space and a right space is provided at the inner side absorbing member 42; however, the present disclosure is not limited thereto, and a configuration may be such that only one internal space is provided, similarly to the outer side absorbing member 40. Further, similarly to the inner side absorbing member 42, the outer side absorbing member 40 may be configured so as to include two spaces, that is a left space and a right space.

Note that the outer side absorbing member 40 and the inner side absorbing member 42 are disposed at approximately the same height. In other words, the outer side absorbing member 40 and the inner side absorbing member 42 are disposed at positions that overlap with each other as viewed from the vehicle width direction.

A second impact absorbing member 44 is provided between the rocker 22 and the rocker molding 36. Similarly to the outer side absorbing member 40 and the inner side absorbing member 42, the second impact absorbing member 44 is formed of a hollow member, and is disposed at a position that overlaps with the outer side absorbing member 40 and the inner side absorbing member 42 as viewed from the vehicle width direction. Note that the overlapping position herein is not limited to a configuration in which the entire area of the second impact absorbing member 44 overlaps with the outer side absorbing member 40 and the inner side absorbing member 42, but is a concept broadly including a configuration in which a portion of the second impact absorbing member 44 is disposed at a position that overlaps with the outer side absorbing member 40 and the inner side absorbing member 42.

Further, when viewed from the vehicle width direction, the outer side absorbing member 40, the inner side absorbing member 42, and the second impact absorbing member 44 are disposed at positions that overlap with a lower portion of the front side door 12, and are disposed at positions that overlap with the cross member 30.

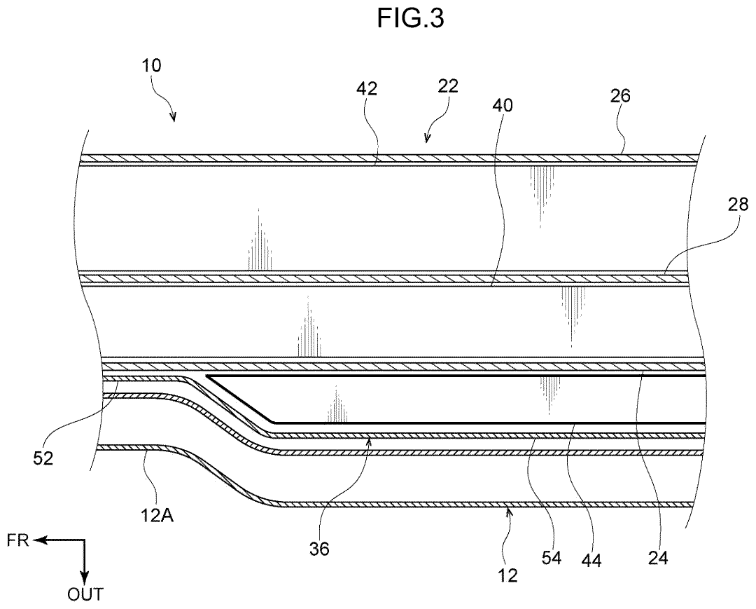

FIG. 3 is a cross-sectional view taken along line 3-3 in FIG. 2. As illustrated in FIG. 3, the concave portion 12A is provided at the front portion of the front side door 12, such that a rear portion of the front side door 12 is positioned further toward the vehicle width direction outer side than the front portion of the front side door 12.

Further, the rocker molding 36 is formed along the shape of the front side door 12, and a position corresponding to the concave portion 12A is an adjacent portion 52 that is adjacent to the rocker 22 in plan view. Further, in the rocker molding 36, a position corresponding to the rear portion of the front side door 12 is a separation portion 54 that is separated from the rocker 22.

Note that the second impact absorbing member 44 is disposed, at the separation portion 54, between the rocker 22 and the rocker molding 36, and the second impact absorbing member 44 is not provided at the adjacent portion 52.

### Operation

Explanation follows regarding operation of the vehicle lower portion structure according to the present exemplary embodiment.

As illustrated in FIG. 2, in the present exemplary embodiment, the rocker 22 is provided at the side section of the vehicle 10, and the rocker 22 extends in the vehicle front-rear direction. Further, the rocker molding 36 is provided further toward the vehicle width direction outer side than the rocker 22, and the rocker molding 36 covers the rocker 22 from the vehicle width direction outer side.

The outer side absorbing member 40 and the inner side absorbing member 42, which serve as the first impact absorbing member, are provided at the interior of the rocker 22. Therefore, during a side-on collision of the vehicle 10, at least a portion of an impact load is absorbed by the outer side absorbing member 40 and the inner side absorbing member 42.

The second impact absorbing member 44 is disposed at a position that overlaps with the outer side absorbing member 40 and the inner side absorbing member 42 as viewed from the vehicle width direction, between the rocker 22 and the rocker molding 36. This enables an impact load that is input to the rocker molding 36 during a side-on collision of the vehicle 10 to be effectively absorbed by the outer side absorbing member 40, the inner side absorbing member 42, and the second impact absorbing member 44.

In the present exemplary embodiment, the rocker 22 includes the rocker outer panel 24, the rocker inner panel 26, and the rocker reinforcement 28, and the internal space of the rocker 22 is divided into a left space and a right space by the rocker reinforcement 28.

The outer side absorbing member 40, the inner side absorbing member 42, and the second impact absorbing member 44 are disposed at positions that overlap with each other as viewed from the vehicle width direction. This enables an impact load that is input during a side-on collision to be effectively absorbed by the three absorbing members.

In the present exemplary embodiment, an impact load is input to the rocker molding 36 from the front side door 12 during a side-on collision, such that the impact load can be distributed in the vehicle front-rear direction more than in a case in which an impact load is directly input to the rocker molding 36.

In the present exemplary embodiment, the lateral wall portion 36C that configures the rocker molding 36 is fixed to the undercover 34, such that a portion of a load during a side-on collision can be transmitted to the non-collision side via the rocker molding 36 and the undercover 34.

Further, as illustrated in FIG. 3, in the present exemplary embodiment, even in a case in which the front side door 12 is provided with a design face that is curved, the second impact absorbing member 44 is disposed between the rocker 22 and the separation portion 54 of the rocker molding 36, thereby enabling collision safety performance during a side-on collision to be ensured. Namely, in a case in which the second impact absorbing member 44 is not provided, a space is provided between the rocker molding 36 and the rocker outer panel 24, such that an impact load cannot be absorbed in this region, and a colliding object travels without energy absorption and hits the rocker outer panel 24. In contrast thereto, filling the gap with the second impact absorbing member 44 as in the present exemplary embodiment enables an impact load to be effectively absorbed.

Although explanation has been given regarding the vehicle lower portion structure according to the present disclosure, obviously various embodiments may be implemented within a range not departing from the gist of the present disclosure. For example, in the present exemplary embodiment, as illustrated in FIG. 1, the concave portion 12A is formed in the front side door 12; however, the present disclosure is not limited thereto, and a structure not including the concave portion 12A may be adopted.

Further, as illustrated in FIG. 2, in the present exemplary embodiment, the rocker 22 includes the rocker outer panel 24, the rocker inner panel 26, and the rocker reinforcement 28, and the outer side absorbing member 40 and the inner side absorbing member 42 are disposed in the internal space; however, the present disclosure is not limited thereto. For example, a rocker may be configured by the rocker outer panel 24 and the rocker inner panel 26 without providing the rocker reinforcement 28. In such a case, only one first impact absorbing member may be provided at the interior of the rocker 22.

Further, in the present exemplary embodiment, steel plates are joined together to form the rocker 22; however, the present disclosure is not limited thereto. For example, a rocker may be formed using a metal extrusion molded product or the like.

Further, in the present exemplary embodiment, the battery case 32 is provided under a floor of the vehicle 10; however, the present disclosure is not limited thereto, and the present disclosure may be applied to a vehicle that does not include a battery under the floor.

With regard to the above-described exemplary embodiment, the following additional notes are disclosed.

### Additional Note 1

A vehicle lower portion structure includes: a rocker that is provided at a side section of a vehicle and that extends in a vehicle front-rear direction; a rocker molding that is disposed further toward a vehicle width direction outer side than the rocker and that covers the rocker from the vehicle width direction outer side; a first impact absorbing member that is provided at an interior of the rocker; and a second impact absorbing member that is disposed between the rocker and the rocker molding, at a position that overlaps with the first impact absorbing member as viewed from a vehicle width direction.

### Additional Note 2

The vehicle lower portion structure according to Additional Note 1, wherein: the rocker includes a rocker outer panel, a rocker inner panel, and a rocker reinforcement that is provided between the rocker outer panel and the rocker inner panel and that divides a space into a left space and a right space; the first impact absorbing member includes an outer side absorbing member that is disposed between the rocker outer panel and the rocker reinforcement, and an inner side absorbing member that is disposed between the rocker inner panel and the rocker reinforcement; and the outer side absorbing member, the inner side absorbing member, and the second impact absorbing member are disposed at positions that overlap with each other as viewed from the vehicle width direction.

### Additional Note 3

The vehicle lower portion structure according to Additional Note 1 or Additional Note 2, wherein: a side door is provided further toward the vehicle width direction outer side than the rocker molding; and a lower portion of the side door is disposed at a position that overlaps with the first impact absorbing member and the second impact absorbing member as viewed from the vehicle width direction.

### Additional Note 4

The vehicle lower portion structure according to any one of Additional Note 1 to Additional Note 3, wherein: the rocker molding includes a vertical wall portion that covers a vehicle width direction outer side of the rocker, and a lateral wall portion that covers a vehicle lower side of the rocker; and the lateral wall portion is fixed to an undercover that configures a lower face of the vehicle.

### Additional Note 5

The vehicle lower portion structure according to any one of Additional Note 1 to Additional Note 4, wherein: the rocker molding includes an adjacent portion that is adjacent to the rocker, and a separation portion that is separated from the rocker, in plan view; and the second impact absorbing member is disposed, at the separation portion, between the rocker and the rocker molding.

What is claimed is:

1. A vehicle lower portion structure, comprising:
a rocker that is provided at a side section of a vehicle and that extends in a vehicle front-rear direction;
a rocker molding that is disposed further toward a vehicle width direction outer side than the rocker and that covers the rocker from the vehicle width direction outer side;
a first impact absorbing member that is provided at an interior of the rocker; and
a second impact absorbing member that is disposed between the rocker and the rocker molding, at a position that overlaps with the first impact absorbing member as viewed from a vehicle width direction.

2. The vehicle lower portion structure according to claim 1, wherein:
the rocker comprises a rocker outer panel, a rocker inner panel, and a rocker reinforcement that is provided between the rocker outer panel and the rocker inner panel and that divides a space into a left space and a right space;
the first impact absorbing member comprises an outer side absorbing member that is disposed between the rocker outer panel and the rocker reinforcement, and an inner side absorbing member that is disposed between the rocker inner panel and the rocker reinforcement; and
the outer side absorbing member, the inner side absorbing member, and the second impact absorbing member are disposed at positions that overlap with each other as viewed from the vehicle width direction.

3. The vehicle lower portion structure according to claim 1, wherein:
a side door is provided further toward the vehicle width direction outer side than the rocker molding; and
a lower portion of the side door is disposed at a position that overlaps with the first impact absorbing member and the second impact absorbing member as viewed from the vehicle width direction.

4. The vehicle lower portion structure according to claim 1, wherein:
the rocker molding comprises a vertical wall portion that covers a vehicle width direction outer side of the rocker, and a lateral wall portion that covers a vehicle lower side of the rocker; and
the lateral wall portion is fixed to an undercover that configures a lower face of the vehicle.

5. The vehicle lower portion structure according to claim 1, wherein:
the rocker molding comprises an adjacent portion that is adjacent to the rocker, and a separation portion that is separated from the rocker, in plan view; and
the second impact absorbing member is disposed, at the separation portion, between the rocker and the rocker molding.
